(19) United States
(12) Patent Application Publication
(10) Pub. No.: US 2008/0051038 A1
(43) Pub. Date: Feb. 28, 2008

(54) Radio loop-back

(76) Inventors: Dan Hindson, Dunrobin (CA); Michael Cooper, Gatineau (CA)

Correspondence Address: SMART & BIGGAR;P.O. BOX 2999, STATION D, 900-55 METCALFE STREET, OTTAWA, ON, K1P5Y6, CA

(21) Appl. No.: 11/812,155

(22) Filed: Jun. 15, 2007

Related U.S. Application Data
(60) Provisional application No. 60/804,894, filed on Jun. 15, 2006.

(51) Int. Cl. H04B 1/38

(52) U.S. Cl. 455/73

(57) ABSTRACT

A radio having a transmitter, a receiver, and a loop-back circuit is provided. The loop-back circuit, when engaged, feeds a transmission from the transmitter to the receiver. According to an embodiment of the invention, the loop-back circuit utilises at least one electronic component that is also used by the transmitter or the receiver. This can reduce a number of electronic components of the radio. The at least one electronic component might for example include a mixer and/or an oscillator. The mixer generates a mixer output by mixing a signal from the oscillator with the transmission from the transmitter. The loop-back circuit provides the mixer output to the receiver when the loop-back circuit is engaged. In specific implementations, both the mixer and the oscillator are used by the transmitter.

### RELATED APPLICATION

This application claims the benefit from U.S. provisional patent application Ser. No. 60/804,894 filed on Jun. 15, 2006, the entire disclosure of which is herein incorporated by reference.

### FIELD OF THE INVENTION

The present invention relates to RF (Radio Frequency) electronics, and more particularly to a radio having a loop-back circuit and to a method of modifying a radio for RF loop-back.

### BACKGROUND

RF loop-back can be used in a radio to test both the internal components of the radio and some other communication device such as a modem. RF loop-back involves sending a signal from a transmitter in the radio to a receiver in the radio. The signal received at the receiver can be analyzed to determine if the radio is operating properly. For example, if the radio is connected to a modem, the loopback circuit allows verification of the radio and modem without transmitting to another radio. This allows isolation of faults to hardware on one side of an RF link or the other.

Traditionally, RF loop-back circuits comprise a local oscillator, couplers, and a mixer. These components are typically specific to the loop-back function.

Oscillators are also used in baseband to RF conversion. Signals from one or more oscillators are mixed with a baseband signal to produce an RF signal of the desired frequency for transmitting. Likewise, a received RF signal is mixed with signals from one or more oscillators to produce a baseband signal. Where the baseband signals are orthogonal components of a complex signal, non-direct conversion to RF involves modulating a low frequency LO (local oscillator) with the two orthogonal baseband signals at an I/Q modulator to produce a single complex intermediate frequency (IF) signal. The IF signal is then mixed with a signal from a high-frequency oscillator to produce an RF signal at the desired transmit frequency. In non-direct conversion to baseband, the received RF signal is first mixed with a signal from a high frequency LO to produce a complex signal at an IF and then demodulated at an I/Q demodulator with a signal from a low frequency LO to produce two orthogonal signals that make up the baseband signal.

In some radios, one of the transmitter or receiver use direct conversion. Direct conversion is usually used when a modem is collocated with the radio and is common in cellular telephones. It enables a lower cost solution for a highly integrated implementation. For direct conversion, the only conversion stage is the I/Q modulator or demodulator. In these cases, a common high-frequency LO is used and a fixed low frequency LO having a frequency equal to the T/R (transmit/receive) spacing frequency is used on the non-direct side. The T/R frequency is equal to the difference between the transmit and receive frequencies of the radio. For example, if the receiver has direct conversion, the high frequency LO is used for the mixer on the non-direct transmitter side and for the I/Q demodulator on the receiver side. The low frequency LO, set at the T/R frequency, drives the I/Q modulator on the transmitter side. Conversely, if the transmitter has direct conversion, the high frequency LO is used for the mixer on the non-direct receive side and for the I/Q modulator on the transmit side. The low frequency LO, set at the T/R frequency, drives the I/Q demodulator on the receive side.

Loop-back circuits are not commonly used in radios with direct conversion.

### SUMMARY OF THE INVENTION

According to a broad aspect, there is provided a radio comprising: a transmitter; a receiver; and a loop-back circuit that when engaged feeds a transmission from the transmitter to the receiver; wherein the loop-back circuit utilises at least one electronic component that is also used by the transmitter or the receiver for a function other than a loop-back function.

According to another broad aspect, there is provided a method comprising: feeding a transmission from a transmitter to a receiver via a loop-back circuit when the loop-back circuit is engaged; wherein feeding the transmission comprises using at least one electronic component that is also used by the transmitter or the receiver for a function other than a loop-back function.

According to another broad aspect, there is provided a method of modifying a radio for RF (Radio Frequency) loop-back, the radio having a transmitter, a receiver, and an oscillator that oscillates at a frequency equal to a difference between a transmit frequency and a receiving frequency, the method comprising: connecting a mixer to the oscillator and the transmitter, the mixer having as inputs a signal from the oscillator and another signal from the transmitter; and connecting a switch for switchably connecting and disconnecting an output from the mixer to the receiver, the output comprising a result of mixing the signal from the oscillator and the another signal from the transmitter; wherein at least one of the oscillator and the mixer has a function other than a loop-back function.

According to another broad aspect, there is provided a loop-back circuit in a direct conversion radio comprising an oscillator that produces a signal at a given frequency for the direct conversion radio, the given frequency being based on a difference between a transit frequency and a receive frequency.

By using at least one electronic component for more than one function, embodiments of the present invention can reduce the number of components used in a radio with loop-back functionality. This can also reduce the amount of modification required to add loop-back functionality to an existing radio. Also, this can reduce cost of the radio due to fewer components being implemented. It is to be understood that the “at least one electronic component” is not merely a wire or a set of wires. Rather, it includes one or more electronic components for example a coupler, a mixer, and/or an oscillator. More generally, the at least one electronic component can include one or more of an active component, a semiconductor, a non-linear device, and/or any device that generates or conditions or modifies a signal.

Other aspects and features of the present invention will become apparent, to those ordinarily skilled in the art, upon review of the following description of the specific embodiments of the invention.

### BRIEF DESCRIPTION OF THE DRAWINGS

Examples of embodiments of the invention will now he described in greater detail with reference to the accompanying drawings, in which:

FIG. 1 is a schematic diagram of a radio having a loop-back circuit according to an embodiment of the present invention;

FIG. 2 is a schematic diagram of another radio having a loop-back circuit according to another embodiment of the present invention;

FIG. 3 is a schematic diagram of another radio having a loop-back circuit according to another embodiment of the present invention;

FIG. 4 is a schematic diagram of another radio having a loop-back circuit according to another embodiment of the present invention; and

FIG. 5 is a flow-chart of a method of modifying a radio for RF (Radio Frequency) loop-back according to another embodiment of the present invention.

### DETAILED DESCRIPTION OF EMBODIMENTS

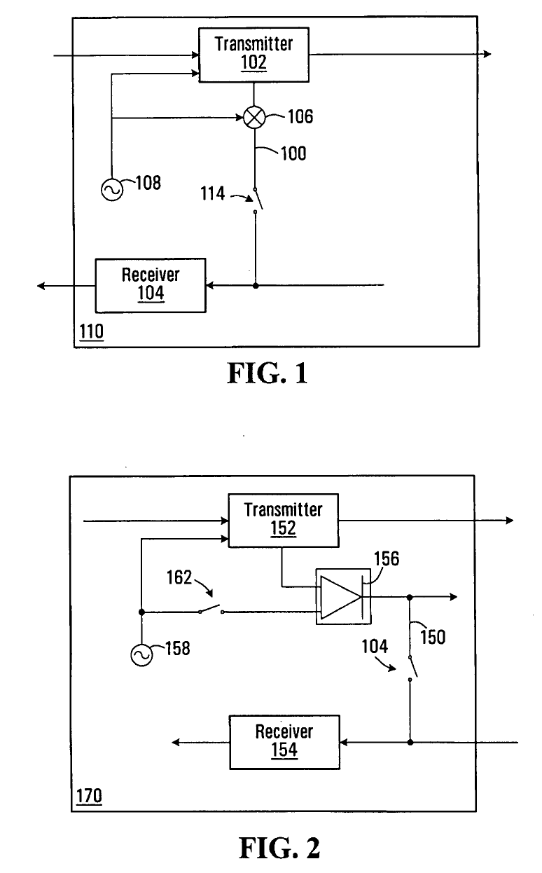

Referring to FIG. 1, shown is a schematic diagram of a radio 110 having a loop-back circuit 100 according to an embodiment of the present invention. The radio 110 comprises a transmitter 102, a receiver 104, a mixer 106 and an oscillator 108. The mixer 106 has as an input a signal from the transmitter 102 and as another input, a signal from the oscillator 108. The oscillator 108 is for at least a first function. In some embodiments the first function is to provide a low frequency signal to an I/Q modulator or demodulator at either the transmitter or receiver side, respectively, of the radio. For illustrative purposes only, the oscillator shown in FIG. 1 is on the transmitter side and provides a low frequency signal to the transmitter. In some embodiments, the oscillator is on the receiver side and provides a low frequency signal a demodulator at the receiver.

The loop-back circuit 100 comprises a switch 114. The switch 114 is connected between the mixer 106 and the receiver 104 and is for switchably connecting and disconnecting the output of the mixer 106 to the receiver 104. When the switch 114 is closed, the loop-back function is activated. The output of the mixer comprises the result of mixing the signal from the oscillator 108 and the signal from the transmitter. In some embodiments, the input signal from the transmitter is an IF signal and the output from the mixer 106 is an RF signal.

In some embodiments, the oscillator oscillates at a frequency equal to a T/R (transmit/receive) spacing frequency, where the T/R spacing frequency is the difference between the transmit frequency of the radio and the receive frequency of the radio. Thus, in these embodiments, the signal output from the mixer 106 is at the receive frequency if the radio is operating properly. In radios where either the transmitter or receiver performs direct conversion, the fixed low frequency LO produces a signal at the T/R spacing frequency. The low frequency LO in those radios can be used as the oscillator 108 for the loop-back circuit 100 in some embodiments of the present invention.

In some embodiments, the signal from the transmitter 102 is an RF signal. In some embodiments, the loop-back circuit is an RF circuit.

In some embodiments, the first function of the oscillator 108 comprises driving a modulator or demodulator. For example, the oscillator 108 may be the low frequency LO for driving an I/Q modulator in a radio where the input to the transmitter 102 is a baseband signal. In some embodiments, the modulator driven by the oscillator 108 is located at the transmitter side of the radio 110. In some of these embodiments, the receiver 104 performs direct conversion from RF to baseband. In other embodiments, a demodulator driven by the oscillator 108 is located at the receiver side of the radio 110. In some of these embodiments, the transmitter 102 performs direct conversion from baseband to RF.

Non-limiting examples of the switch 114 are selected from the group consisting of a single-pole-single-throw switch; an amplifier; and combinations thereof.

In some embodiments, the mixer 106 comprises a diode. An example of this is provided below with reference to FIG. 2. Note that there may be more than one diode. Alternatively, the mixer 106 can include any appropriate non-linear device, for example a transistor. Example transistors that may be employed include a FET (Field Effect Transistor), and a BJT (Bipolar Junction Transistor). Other possibilities for the mixer 106 exist. In some embodiments, the mixer 106 is used for another function in the radio 110 other than the loop-back function.

Referring now to FIG. 2, shown is a schematic diagram of another radio 170 having a loop-back circuit 150 according to another embodiment of the present invention. The radio 170 comprises a transmitter 152, a receiver 154, an oscillator 158, and a diode 156 as a mixer. The diode 156 has as inputs at least a part of a signal from the transmitter 152 and another signal from the oscillator 158. A switch 104 directs an output from the diode 156 to the receiver 154 and a further switch 162 directs the signal from the oscillator 158 to the diode 156. When both switches are closed, the loop-back circuit 150 is complete and the diode 156 mixes the two input signals to produce the output that is directed to the receiver 154. More particularly, the diode 156 acts as a mixer and mixes the two signals to produce a signal at a frequency equal to the sum and difference of the transmit frequency and the oscillator frequency. The output of the diode 156 comprises the result of mixing the signal from the oscillator and the signal from the transmitter.

In some embodiments, the diode 156 comprises a detector diode used for detecting transmit power. In these embodiments, a portion of the transmit signal is tapped off the transmit path and fed to the detector diode. The detector diode generates a DC signal that is proportional to the power incident on the diode and thus proportional to the transmit power.

Loop-back circuits in embodiments of the present invention are implemented on printed circuit boards, integrated circuits or any other means that can be introduced into the radio.

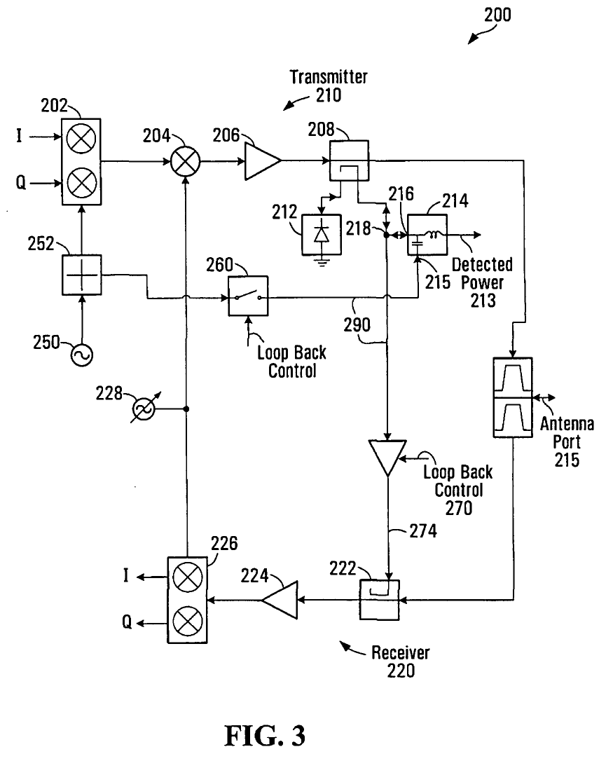

Referring now to FIG. 3, shown is a schematic diagram of another radio 200 having a loop-back circuit 290 according to an embodiment of the present invention. It is to be understood that the radio 200 is shown with a specific arrangement of components for illustrative purposes only.

The radio 200 has a transmitter side 210 and a receiver side 220. Note that some components may be part of both sides 210,220 and therefore there is no boundary shown between the transmitter side 210 and the receiver side 220. At the transmitter side 210, the input signal from a low frequency LO 250 is modulated by I and Q phases of a baseband input signal in an I/Q modulator 202 to produce an IF signal. The frequency of the low frequency LO 250 is equal to the T/R spacing frequency of the radio 200. A splitter 252 splits the signal from the low frequency LO 250 between the I/Q modulator 202 and the loop-back circuit 290. The split may or may not be equal.

The IF signal from the I/Q modulator 202 is fed to a mixer 204 where the IF signal is mixed with a signal from a high frequency LO 228 to produce an RF signal. The output from the mixer 204 is fed to a power amplifier 206 in the transmitter 210. The power amplifier 206 amplifies the output of the mixer 204 increasing the power of the output. After the amplifier 206, a portion of the transmit power is tapped off by a coupler 208 and fed to a detector diode 212 that is connected to ground for DC and RF. The detector diode 212 outputs a rectified signal that is proportional to the power across the detector diode 212 to a port 216 of a diplexer 214, where it passes through a low-pass filter and is output to port 213, which ideally only allows DC signals to pass through. The DC signal at port 213 represents the detected power. The remainder of the signal from the transmitter side 210 proceeds from the coupler 208 to the antenna port 215 for transmission.

At the receiver side 220, RF signals received at the antenna port 215 are directed through a coupler 222 and on to a low noise amplifier 224 that amplifies the RF signals while adding minimal noise. From the low noise amplifier 224, the received signal is fed to an I/Q demodulator 226 where it is demodulated to orthogonal I and Q signals of a baseband signal. The I/Q demodulator 226 also has as an input the high frequency LO 228.

The loop-back circuit 290 provides a loop-back from the transmitter side 210 to the receiver side 220. The loop-back circuit comprises a SPST (single-pole-single throw) switch 260 connected to the low frequency LO 250 through the splitter 252 and to the detector diode 212. When the switch 260 is closed, the signal from the low frequency LO is directed through a port 215 of the diplexer 214, where it passes through a high-pass filter and is output through the port 216. The port 215 does not allow DC to flow through it and therefore, the diplexer 214 enables the signal from the switch 260 and the DC signal generated by detector diode 212 to be extracted/applied to the same circuit location 218 at the port 216. After the diplexer 214, the signal from the low frequency LO 250 is directed to the detector diode 212, where it is mixed with the portion of the transmit power that is coupled off by the coupler 208. The loop-back circuit also comprises a loop-back control amplifier 270 connected between the diode 212 and the coupler 222. The loop-back control amplifier 270 functions as a switch by adjusting its bias to control its gain. When the gain is not reduced, the output from the diode 212 is directed through the coupler 212 and on to the receiver side 220 of the radio 200, thus completing the loop-back. In some embodiments, an attenuator is used on one or both sides of the loop-back control amplifier 270 to adjust the power into the coupler 208 or coupler 222 and improve the match between the various components of the loop-back circuit 290. In operation, when both the switch 260 and the loop-back control amplifier 270 are activated, the loop-back function is operable.

In this specific embodiment, the oscillator 250 is used for two functions, modulation of the incoming signal and loop-back. Additionally, the diode 212 is used for two functions, as a detector diode, and as a mixer for the loop-back. By using existing components, the loop-back circuit can be added to the radio 200, while reducing the extra space and components used.

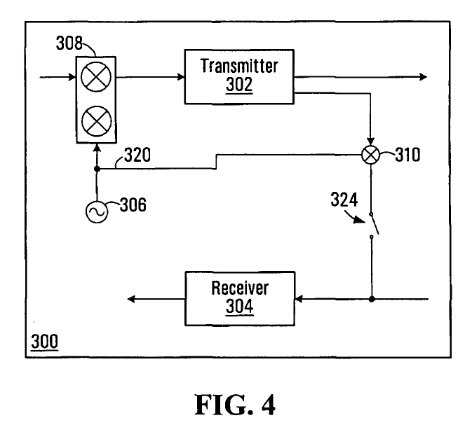

FIG. 4 is a schematic diagram of another radio 300 having a loop-back circuit according to another embodiment of the present invention. The radio 300 comprises a transmitter 302, a receiver 304, and a low-frequency oscillator 306. The low-frequency oscillator drives a modulator or demodulator 308 at one of the transmitter and receiver side of the radio. For illustrative purposes, in FIG. 4, the oscillator 306 that is driving the modulator 308 is on the transmitter side. However, it is to be understood that the oscillator 306 may instead drive a demodulator on the receive side. The low-frequency oscillator 306 oscillates at a frequency equal to a difference between a transmit frequency and a receiving frequency. The other of the transmitter or receiver side is configured for direct conversion to baseband. Thus in FIG. 4, the receiver side is configured for direct conversion. The radio 300 further comprises an RF loop-back circuit 320 that comprises a mixer 310 and a switch 324. The mixer 310 receives as an input, at least a part of a signal from the transmitter 302 and at least a part of a signal from the oscillator 306. The switch 324 is connected between the mixer 310 and the receiver 304 and is for directing an output of the diode 310 to the receiver 304. The output of the mixer 310 comprises a result of mixing the part signal from the oscillator 306 and the part of the signal from the transmitter.

In some embodiments, the radio 300 also comprises a coupler for directing the part of the transmit signal to the mixer 310. As with other embodiments, the mixer might be based on a diode, for example a detector diode. Other implementations are possible for the mixer.

In some embodiments, the radio 300 also comprises an activator for activating the switch 324. The switches of embodiments of the present invention may be controlled by hardware, software or combinations thereof. For example, the switches can be controlled by software activated remotely or by a button on the radio.

In some embodiments of the radio 300, the one of the transmitter and receiver with the modulator or demodulator is configured for non-direct conversion to baseband. A non-limiting example of non-direct conversion is double up/down conversion.

In some embodiments, the radio 300 further comprises a high-frequency oscillator tuned to select a desired channel for the direct conversion. In exemplary embodiments, the frequency of the high frequency LO in direct conversion is the centre frequency of the signal that is transmitted in a direct transmitter and is the centre of the signal that is converted to baseband in a direct receiver. Thus, the high frequency LO may select the desired channel. In some of these embodiments, the high-frequency oscillator is also for driving a modulator in non-direct conversion on the other side of the radio.

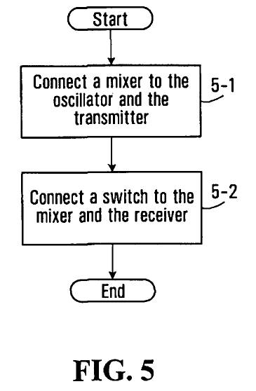

Referring now to FIG. 5, shown is a flowchart of a method of modifying a radio for RF loop-back according to another embodiment of the present invention. For this method, it is assumed that the radio has a transmitter, a receiver, and an oscillator that oscillates at a frequency equal to a difference between a transmit frequency and a receiving frequency. The method comprises two steps. Step 5-1 is connecting a mixer to the oscillator and the transmitter. The next step, Step 5-2 is connecting a switch between the mixer and the receiver, the switch being for switchably connecting and disconnecting an output from the mixer to the receiver, the output comprising a result of mixing the signal from the oscillator and the signal from the transmitter to produce a signal at the receive frequency.

In some embodiments the mixer comprises a diode. The diode may be a diode that is already used for another function in the radio. In some embodiments, the method further comprises connecting a further switch between the oscillator and the mixer or diode.

What has been described is merely illustrative of the application of the principles of the invention. Other arrangements and methods can be implemented by those skilled in the art without departing from the spirit and scope of the present invention.

1. A radio comprising:
a transmitter;
a receiver; and
a loop-back circuit that when engaged feeds a transmission from the transmitter to the receiver;
wherein the loop-back circuit utilises at least one electronic component that is also used by the transmitter or the receiver for a function other than a loop-back function.

2. The radio of claim 1 wherein the at least one electronic component comprises a mixer.

3. The radio of claim 2 wherein the mixer is configured to generate a mixer output by mixing a signal from an oscillator with the transmission from the transmitter, the loop-back circuit providing the mixer output to the receiver when the loop-back circuit is engaged.

4. The radio of claim 2 wherein the mixer is used by the transmitter for detecting transmit power.

5. The radio of claim 2 wherein the mixer comprises a diode.

6. The radio of claim 1 wherein the at least one electronic component comprises an oscillator.

7. The radio of claim 6 wherein a mixer is configured to generate a mixer output by mixing a signal from the oscillator with the transmission from the transmitter, the loop-back circuit providing the mixer output to the receiver when the loop-back circuit is engaged.

8. The radio of claim 6 wherein the oscillator is used by the transmitter to drive a modulator.

9. The radio of claim 8 wherein the receiver performs direct conversion from RF to baseband, the radio further comprising:
a high-frequency oscillator tuned to select a desired channel for the direct conversion.

10. The radio of claim 6 wherein the oscillator is used is used by the receiver to drive a demodulator.

11. The radio of claim 10 wherein the transmitter performs direct conversion from baseband to RF, the radio further comprising:
a high-frequency oscillator tuned to select a desired channel for the direct conversion.

12. The radio of claim 6 wherein the oscillator provides a signal to a first modulator, each of said transmitter and receiver comprises a second modulator, one of said second modulators being arranged for modulating a signal from the modulator driven by said oscillator, and a further oscillator for providing a signal to each of said second modulators.

13. The radio of claim 1 wherein the at least one electronic component comprises both a mixer and an oscillator, the mixer being configured to generate a mixer output by mixing a signal from the oscillator with the transmission from the transmitter, the loop-back circuit providing the mixer output to the receiver when the loop-back circuit is engaged.

14. The radio of claim 6 wherein the oscillator oscillates at a frequency equal to a difference between a transmit frequency and a receive frequency.

15. The radio of claim 1 wherein the loop-back circuit comprises at least one switch for engaging the loop-back circuit.

16. The radio of claim 15 wherein the at least one switch comprises at least one of a single-pole-single-throw switch, and an amplifier.

17. The radio of claim 15 further comprising an activator for activating the at least one switch.

18. The radio of claim 15 wherein the at least one switch is controlled by at least one of hardware, and software.

19. The radio of claim 1 further comprising at least one coupler for directing the transmission from the transmitter to the mixer.

20. A method comprising:
feeding a transmission from a transmitter to a receiver via a loop-back circuit when the loop-back circuit is engaged;
wherein feeding the transmission comprises using at least one electronic component that is also used by the transmitter or the receiver for a function other than a loop-back function.

21. The method of claim 20 wherein the at least one electronic component comprises a mixer.

22. The method of claim 20 wherein the at least one electronic component comprises an oscillator.

23. A method of modifying a radio for RF (Radio Frequency) loop-back, the radio having a transmitter, a receiver, and an oscillator that oscillates at a frequency equal to a difference between a transmit frequency and a receiving frequency, the method comprising:
connecting a mixer to the oscillator and the transmitter, the mixer having as inputs a signal from the oscillator and another signal from the transmitter; and
connecting a switch for switchably connecting and disconnecting an output from the mixer to the receiver, the output comprising a result of mixing the signal from the oscillator and the another signal from the transmitter;
wherein at least one of the oscillator and the mixer has a function other than a loop-back function.

24. A loop-back circuit in a direct conversion radio comprising an oscillator that produces a signal at a given frequency for the direct conversion radio, the given frequency being based on a difference between a transmit frequency and a receive frequency.
